(19) United States
(12) Patent Application Publication
(10) Pub. No.: US 2026/0083065 A1
(43) Pub. Date: Mar. 26, 2026

(54) HYDRAULIC CONTROL SYSTEM FOR A BALE WRAP FEEDING ASSEMBLY OF AN AGRICULTURAL HARVESTER

(71) Applicant: CNH Industrial America LLC, New Holland, PA (US)

(72) Inventors: John Bradley Wickizer, Davenport, IA (US); Daniel Dallman, Eldridge, IA (US)

(21) Appl. No.: 19/337,015

(22) Filed: Sep. 23, 2025

Related U.S. Application Data
(60) Provisional application No. 63/697,638, filed on Sep. 23, 2024.

(51) Int. Cl. A01F 15/08; A01F 15/10

(52) U.S. Cl. CPC A01F 15/0833; A01F 15/106

(57) ABSTRACT

A hydraulic control system for a bale wrap feeding assembly of an agricultural harvester includes a controller configured to control a control valve to move to a first position to enable hydraulic fluid to flow from a source to a first side of a hydraulic motor. Furthermore, the controller, in response to determining a speed of the hydraulic motor is greater than a threshold speed, is configured to control the control valve to move to a second position to enable the hydraulic fluid to flow from a reservoir to the first side of the hydraulic motor and to enable the hydraulic fluid to flow from a second side of the hydraulic motor to a proportional relief valve, and to control the proportional relief valve to control a pressure of the hydraulic fluid flowing from the second side of the hydraulic motor.

### CROSS-REFERENCE TO RELATED APPLICATION

This application claims priority from and the benefit of U.S. Provisional Application Serial No. 63/697,638, entitled “HYDRAULIC CONTROL SYSTEM FOR A BALE WRAP FEEDING ASSEMBLY OF AN AGRICULTURAL HARVESTER”, filed September 23, 2024, which is hereby incorporated by reference in its entirety.

### BACKGROUND

The present disclosure relates generally to a hydraulic control system for a bale wrap feeding assembly of an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a hydraulic control system for a bale wrap feeding assembly of an agricultural harvester includes a controller having a processor an a memory. The controller is configured to control a control valve to move to a first position to enable hydraulic fluid to flow from a source to a first side of a hydraulic motor to drive the hydraulic motor to rotate in a forward direction. The hydraulic motor is configured to drive a bale wrap toward a bale while being driven to rotate in the forward direction. The controller is also configured to receive a sensor signal indicative of a speed of the hydraulic motor. Furthermore, the controller, in response to determining the speed of the hydraulic motor is greater than a threshold speed, is configured to control the control valve to move to a second position to enable the hydraulic fluid to flow from a reservoir to the first side of the hydraulic motor and to enable the hydraulic fluid to flow from a second side of the hydraulic motor to a proportional relief valve, and to control the proportional relief valve to control a pressure of the hydraulic fluid flowing from the second side of the hydraulic motor.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a perspective view of an embodiment of a bale wrap feeding assembly that may be employed within the agricultural machine system of FIG. 1, in which a frame of the bale wrap feeding assembly is in a feeding position;

FIG. 4 is a perspective view of the bale wrap feeding assembly of FIG. 3, in which the frame is in a loading position;

FIG. 5 is a cross-sectional view of a portion of the bale wrap feeding assembly of FIG. 3;

FIG. 6 is a perspective view of a portion of the bale wrap feeding assembly of FIG. 3;

FIG. 7 is a perspective view of another portion of the bale wrap feeding assembly of FIG. 3;

FIG. 8 is a perspective view of a further portion of the bale wrap feeding assembly of FIG. 3;

FIG. 9 is a schematic diagram of an embodiment of a hydraulic control system that may be employed within the bale wrap feeding assembly of FIG. 3; and

FIG. 10 is a flow diagram of an embodiment of a method for controlling a hydraulic motor of a bale wrap feeding assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

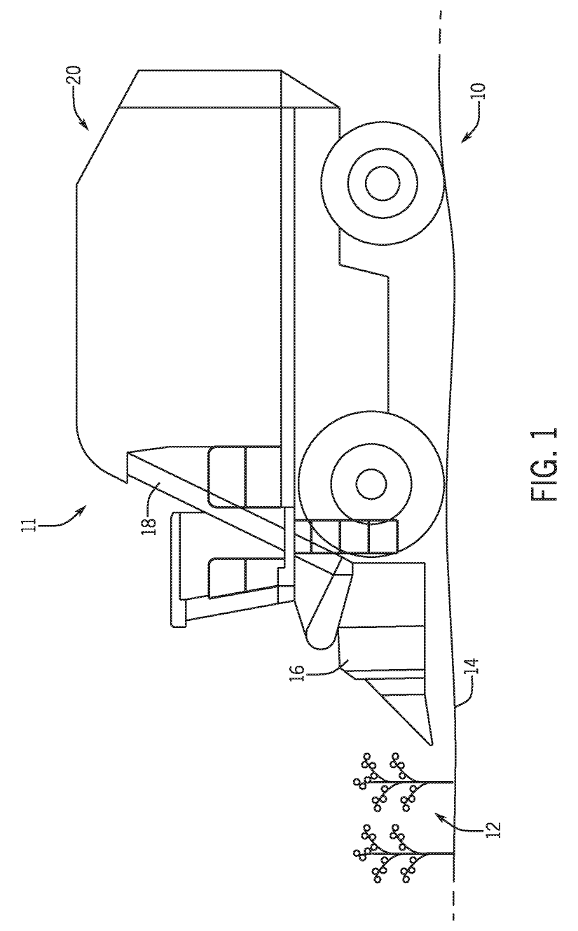

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

As discussed in detail below, the agricultural machine system 10 includes a bale wrap feeding assembly configured to feed the bale wrap toward the bale. The bale wrap feeding assembly includes one or more rollers and/or one or more belts driven by a hydraulic motor. The roller(s) and/or the belt(s) are configured to engage the bale wrap and to drive the bale wrap toward the bale as the roller(s) and/or the belt(s) are driven by the hydraulic motor. In certain embodiments, the bale wrap feeding assembly includes a hydraulic control system having a controller that includes a processor and a memory. The controller is configured to control a control valve to move to a first position to enable hydraulic fluid to flow from a source to a first side of the hydraulic motor to drive the hydraulic motor to rotate in a forward direction. The hydraulic motor is configured to drive the bale wrap toward the bale while being driven to rotate in the forward direction (e.g., by driving the roller(s) and/or the belt(s) to rotate in respective forward direction(s)). The controller is also configured to receive a sensor signal indicative of a speed of the hydraulic motor. In response to determining the speed of the hydraulic motor is greater than a threshold speed (e.g., 50 RPM), the controller is configured to control the control valve to move to a second position to enable the hydraulic fluid to flow from a reservoir to the first side of the hydraulic motor and to enable the hydraulic fluid to flow from a second side of the hydraulic motor to a proportional relief valve. In addition, in response to determining the speed of the hydraulic motor is greater than the threshold speed, the controller is configured to control the proportional relief valve to control a pressure of the hydraulic fluid flowing from the second side of the hydraulic motor. For example, in certain embodiments, in response to determining the speed of the hydraulic motor is greater than the threshold speed, the controller is configured to control the proportional relief valve to control the pressure of the hydraulic fluid flowing from the second side of the hydraulic motor based on the speed of the hydraulic motor (e.g., such that the speed of the hydraulic motor is within a threshold range of a target speed, such as 100 RPM). Furthermore, in certain embodiments, in response to determining the speed of the hydraulic motor is greater than the threshold speed, the controller is configured to control the proportional relief valve to control the pressure of the hydraulic fluid flowing from the second side of the hydraulic motor based on the pressure of the hydraulic fluid flowing from the second side of the hydraulic motor (e.g., such that the pressure of the hydraulic fluid flowing from the second side of the hydraulic motor is within a threshold range of a target pressure).

As discussed in detail below, as the bale wrap is fed toward the bale, the bale wrap is captured between the bale and belt(s) that form the bale. Accordingly, rotation of the bale draws the bale wrap around the bale, thereby wrapping the bale. In response to the bale wrap being captured between the bale and the belt(s) that form the bale, the speed of the bale wrap may increase, thereby increasing the speed of the hydraulic motor. In response to the speed of the hydraulic motor increasing above the threshold speed (e.g., which indicates that the bale wrap is captured between the bale and the belt(s) that form the bale), the controller may move the control valve from the first position, which causes the hydraulic motor to drive the bale wrap toward the bale, to the second position, which enables the proportional relief valve to control the pressure of the hydraulic fluid flowing from the second side of the hydraulic motor. Controlling the pressure of the hydraulic fluid flowing from the second side of the hydraulic motor controls a rotational resistance of the hydraulic motor in the forward direction, thereby controlling a rotational resistance of the roller(s) and/or the belt(s) of the bale wrap feeding assembly in the respective forward direction(s). The rotational resistance of the roller(s) and/or the belt(s) of the bale wrap feeding assembly may be controlled, such that the roller(s) and/or the belt(s) cause the bale wrap to move slower at the bale wrap feeding assembly than at the bale, thereby establishing tension within the bale wrap, which stretches the bale wrap (e.g., by 5 percent, by 10 percent, by 15 percent, etc.). Stretching the bale wrap facilitates adhesion of the bale wrap to itself as the bale wrap wraps around the bale, thereby coupling the bale wrap to the bale. Furthermore, the tension within the bale wrap may substantially maintain the round shape of the bale, thereby facilitating storage and transport of the wrapped bale. In addition, maintaining tension within the bale wrap may substantially reduce or eliminate the possibility of loose bale wrap material collecting within the agricultural machine system, thereby substantially reducing or eliminating the possibility of bale wrap clogging.

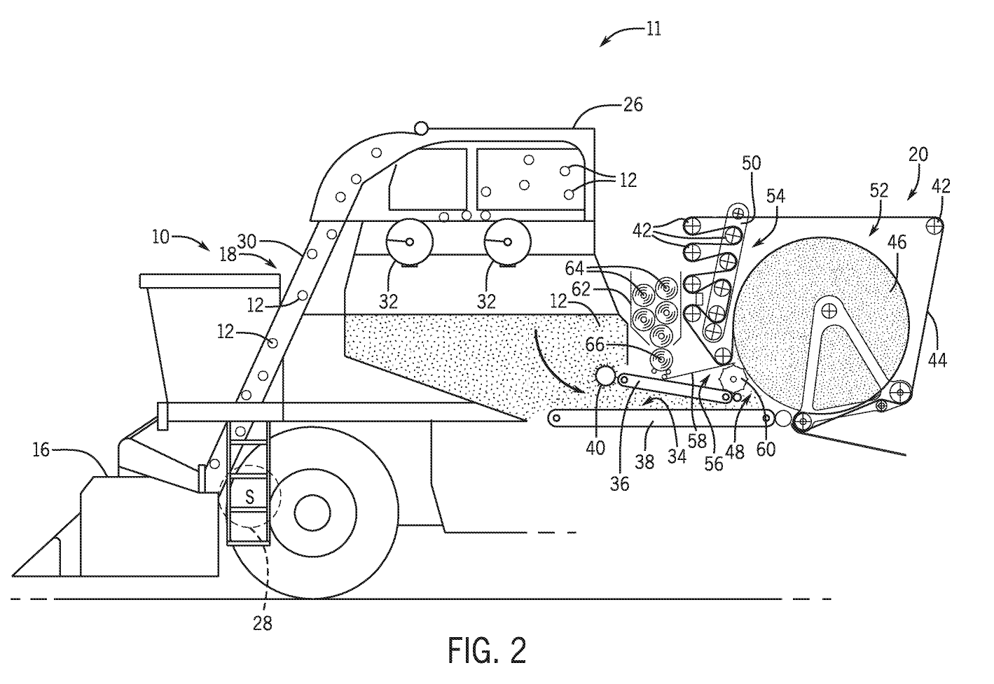

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to the accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 configured to distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a first belt (e.g., belt) 36 configured to move the agricultural product 12 from the accumulator assembly 26 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator assembly 26 to the baler 20. Furthermore, in the illustrated embodiment, the conveying system 34 includes an agitation roller 40 positioned upstream of the first belt 36. The agitation roller 40 is configured to agitate the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more rollers and/or one or more belts of a bale wrap feeding assembly. The roller(s) and/or the belt(s) drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator assembly 26 to the baler 20 and to form the bale 46. For example, as the agricultural machine system 10 traverses a field, the agricultural product 12 may accumulate within the accumulator assembly 26. After a selected duration, the conveying system 34 may be activated to transfer the agricultural product 12 from the accumulator assembly 26 to the baler 20. For example, the conveying system 34 may move the agricultural product 12 toward the baler 20 at a significantly faster rate than the air-assisted conveying system 18 moves the agricultural product 12 into the accumulator assembly 26. Concurrently with activation of the conveying system 34, the baler 20 may be activated to initiate the bale forming process, as described above. After another selected duration, the conveying system 34 and the baler 20 may be deactivated to enable the accumulator assembly 26 to collect additional agricultural product 12. In certain embodiments, the conveying assembly 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, as discussed in detail below, the agricultural machine system 10 (e.g., the bale wrapping system 56 of the agricultural machine system 10) includes a bale wrap feeding assembly configured to receive an active bale wrap assembly 66 from the bale wrap assembly storage compartment 62 and to feed the bale wrap 58 of the active bale wrap assembly 66 toward the bale 46 (e.g., toward the starter roller 60). The bale wrap feeding assembly includes one or more rollers and/or one or more belts driven by hydraulic motor(s). The roller(s) and/or the belt(s) are configured to engage the bale wrap and to drive the bale wrap toward the bale as the roller(s) and/or the belt(s) are driven by the hydraulic motor(s).

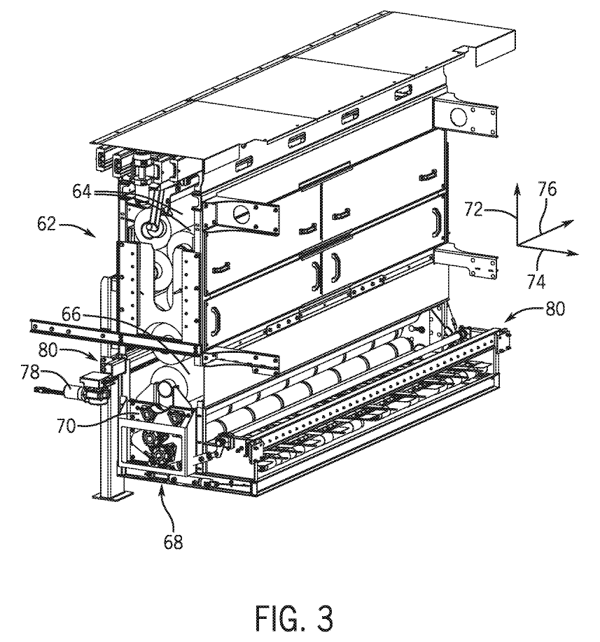

FIG. 3 is a perspective view of an embodiment of a bale wrap feeding assembly 68 that may be employed within the agricultural machine system of FIG. 1, in which a frame 70 of the bale wrap feeding assembly 68 is in a feeding position. As previously discussed, the bale wrap assembly storage compartment 62 is configured to store multiple bale wrap assemblies 64. In addition, the bale wrap assembly storage compartment 62 is configured to feed the active bale wrap assembly 66 downwardly with respect to a vertical axis 72 of the agricultural machine system to the bale wrap feeding assembly 68. The bale wrap feeding assembly 68 is configured to receive the active bale wrap assembly 66 from the bale wrap assembly storage compartment 62 while the frame 70 is in the illustrated feeding position. In addition, while the frame 70 is in the illustrated feeding position, the bale wrap feeding assembly 68 is configured to feed the bale wrap of the active bale wrap assembly 66 toward the bale with respect to a longitudinal axis 74 of the agricultural machine system. While the bale wrap feeding assembly 68 is configured to receive the active bale wrap assembly 66 from the bale wrap assembly storage compartment 62 in the illustrated embodiment, in other embodiments, the bale wrap assembly storage compartment may be omitted. In such embodiments, the bale wrap feeding assembly may receive the active bale wrap while the frame is in the loading position.

The frame 70 is configured to move with respect to a lateral axis 76 between the illustrated feeding position and the loading position. As discussed in detail below, with the frame 70 in the loading position, the bale wrap of the active bale wrap assembly 66 may be loaded through the feed rollers of the bale wrap feeding assembly 68. In the illustrated embodiment, the bale wrap feeding assembly 68 includes a motor 78 (e.g., frame drive motor) configured to drive the frame 70 to move between the illustrated feeding position and the loading position. The motor 78 may include an electric motor, a pneumatic motor, a hydraulic motor, another suitable type of motor, or a combination thereof. In certain embodiments, the motor may be omitted and an operator may manually move the frame with respect to the lateral axis between the feeding and loading positions.

In the illustrated embodiment, the bale wrap feeding assembly 68 includes track assemblies 80 configured to guide the frame 70 to move with respect to the lateral axis 76 between the feeding position and the loading position. In the illustrated embodiment, the bale wrap feeding assembly 68 includes two track assemblies 80 positioned on opposite longitudinal sides of the frame 70. However, in other embodiments, the bale wrap feeding assembly may include more or fewer track assemblies (e.g., 1, 3, 4, or more), and each track assembly may be positioned at any suitable location on the frame. In addition, while the bale wrap feeding assembly 68 includes track assemblies 80 in the illustrated embodiment, in other embodiments, the bale wrap feeding assembly may include any other suitable assemblies (e.g., alone or in combination with the track assembly/assemblies) to guide movement of the frame with respect to the lateral axis, such as one or more slot and groove assemblies, one or more protrusion and recess assemblies, etc.

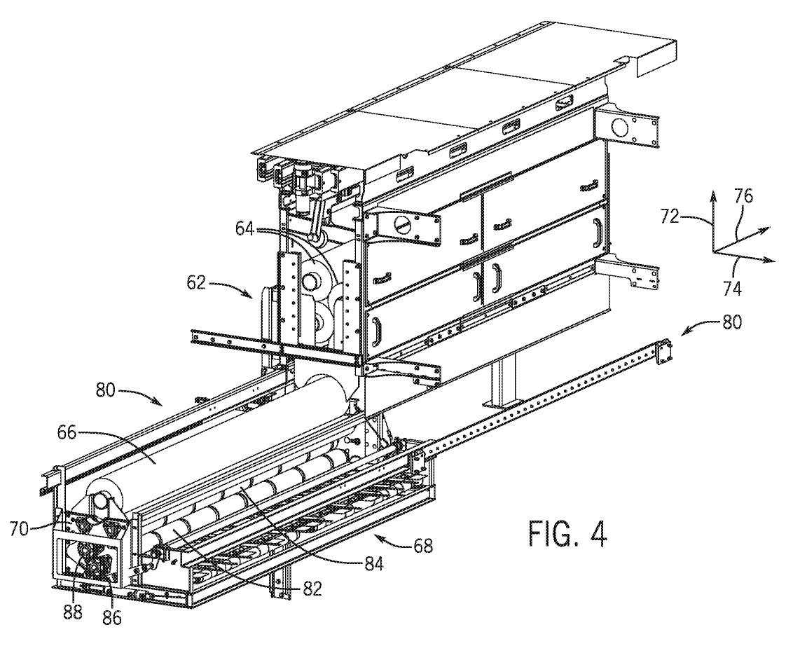

FIG. 4 is a perspective view of the bale wrap feeding assembly 68 of FIG. 3, in which the frame 70 is in a loading position. In the illustrated embodiment, the bale wrap feeding assembly 68 includes a fixed feed roller 82 rotatably and non-movably coupled to the frame 70, and the bale wrap feeding assembly 68 includes a movable feed roller 84 rotatably and movably coupled to the frame 70. In addition, the movable feed roller 84 is movable between the illustrated engaged position and a disengaged position relative to the fixed feed roller 82. The movable feed roller 84 is configured to be positioned proximate to the fixed feed roller 82 while in the engaged position to facilitate feeding the bale wrap of the active bale wrap assembly 66 between the movable feed roller 84 and the fixed feed roller 82. Furthermore, the movable feed roller 84 is configured to be positioned remote from the fixed feed roller 82 while in the disengaged position to facilitate loading the bale wrap of the active bale wrap assembly 66 between the movable feed roller 84 and the fixed feed roller 82. The bale wrap feeding assembly 68 also includes a fixed feed roller gear 86 non-rotatably coupled to the fixed feed roller 82. In addition, the bale wrap feeding assembly 68 includes a movable feed roller gear 88 non-rotatably coupled to the movable feed roller 84. The movable feed roller gear 88 is configured to engage the fixed feed roller gear 86 while the movable feed roller 84 is in the illustrated engaged position to enable rotation of the fixed feed roller 82 to drive rotation of the movable feed roller 84.

With the frame 70 in the illustrated loading position, the bale wrap of the active bale wrap assembly 66 may be loaded into the bale wrap feeding assembly 68. To facilitate the bale wrap loading process, the movable feed roller 84 is moved from the illustrated engaged position to the disengaged position. The bale wrap of the active bale wrap assembly 66 is then loaded between the movable feed roller 84 and the fixed feed roller 82. With the frame 70 in the illustrated loading position, an operator may access the entire lateral extent of the feed rollers, thereby facilitating efficient loading of the bale wrap between the feed rollers. In addition, the ability to move the frame 70 to the illustrated loading position enhances access to multiple components of the bale wrap feeding assembly, thereby facilitating maintenance and repair operations. Furthermore, in certain embodiments, the bale wrap feeding assembly 68 may receive the active bale wrap assembly 66 while the frame is in the illustrated loading position (e.g., in situations in which a type of bale wrap not present in the bale wrap assembly storage compartment is desired, in situations in which the bale wrap assembly storage compartment is empty, in embodiments in which the agricultural machine system does not include the bale wrap assembly storage compartment, etc.)

After the bale wrap is loaded between the feed rollers, the movable feed roller 84 may be moved from the disengaged position to the illustrated engaged position. As a result, the movable feed roller gear 88 engages the fixed feed roller gear 86, thereby enabling rotation of the fixed feed roller 82 to drive rotation of the movable feed roller 84. The frame 70 may then be moved with respect to the lateral axis 76 from the illustrated loading position to the feeding position. For example, the motor disclosed above may drive the frame to move from the illustrated loading position to the feeding position. With the frame in the feeding position, the bale wrap feeding assembly 68 may feed the bale wrap of the active bale wrap assembly 66 toward the bale.

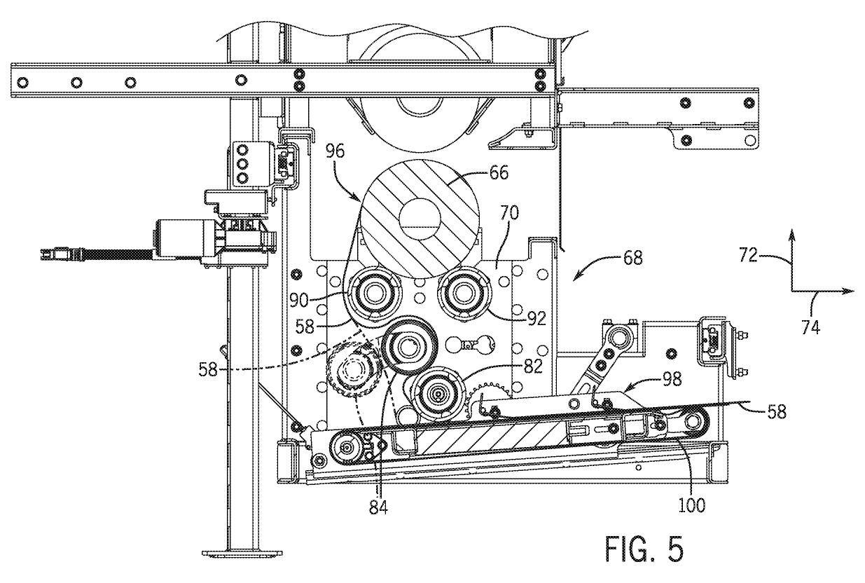

FIG. 5 is a cross-sectional view of a portion of the bale wrap feeding assembly 68 of FIG. 3. In the illustrated embodiment, the bale wrap feeding assembly 68 includes a first support roller 90 and a second support roller 92. Each support roller is rotatably and non-movably coupled to the frame 70, and the first and second support rollers are configured to support the active bale wrap assembly 66 within the bale wrap feeding assembly 68. Accordingly, the bale wrap loading process includes receiving the active bale wrap assembly 66 onto the first support roller 90 and the second support roller 92. The frame 70 is then moved with respect to the lateral axis from the feeding position to the loading position. Next, the first support roller 90 and the second support roller 92 are rotated (e.g., by a motor) to drive the active bale wrap assembly 66 to rotate, such that an end (e.g., leading end) of the bale wrap 58 of the active bale wrap assembly 66 is positioned at a target location 96. In certain embodiments, the end of the bale wrap is coupled to another portion of the bale wrap (e.g., via tape, via adhesive, etc.) to facilitate transport and storage of the bale wrap assembly. Accordingly, positioning the end of the bale wrap at the target location 96 enables an operator to disconnect the connection(s) between the end of the bale wrap and the other portion of the bale wrap, thereby enabling the bale wrap to be loaded into the bale wrap feeding assembly 68.

After the movable feed roller 84 is moved to the disengaged position, shown in dashed lines, the operator routes the bale wrap 58 around the first support roller 90, such that the bale wrap 58 is positioned laterally outwardly from the support rollers. The bale wrap 58 may then be loaded between the movable feed roller 84 and the fixed feed roller 82, such that the bale wrap 58, shown as a dashed line, is positioned between the movable feed roller 84 and the fixed feed roller 82 with respect to the longitudinal axis 74. Next, the movable feed roller 84 is moved to the engaged position, shown in solid lines, thereby capturing the bale wrap 58, shown as a solid line, between the movable feed roller 84 and the fixed feed roller 82. As previously discussed, moving the movable feed roller 84 to the engaged position causes the movable feed roller gear to engage the fixed feed roller gear, thereby enabling rotation of the fixed feed roller 82 to drive rotation of the movable feed roller 84.

In the illustrated embodiment, the bale wrap feeding assembly 68 includes a belt assembly 98 configured to receive the bale wrap 58 from the fixed feed roller 82 and the movable feed roller 84. In addition, the belt assembly 98 is configured to drive the bale wrap 58 to move toward the bale. Accordingly, during the bale wrap loading process, the bale wrap 58 is loaded between the fixed feed roller 82 and belts 100 of the belt assembly 98. The frame 70 is then moved from the loading position to the feeding position. To wrap a bale with the bale wrap 58 of the active bale wrap assembly 66, the first support roller 90, the second support roller 92, the movable feed roller 84, the fixed feed roller 82, and the belts 100 are driven to rotate in respective forward directions, thereby feeding the bale wrap 58 to the starter roller.

While the bale wrap feeding assembly includes two support rollers in the illustrated embodiment, in other embodiments, the bale wrap feeding assembly may include more or fewer support rollers (e.g., 0, 1, 3, 4, or more). For example, in certain embodiments, the support rollers may be omitted, and the bale wrap feeding assembly may include other suitable device(s) to support the active bale wrap assembly (e.g., cradle, support rod(s), support bushing(s), etc.). Furthermore, while the bale wrap feeding assembly includes the belt assembly in the illustrated embodiment, in other embodiments, the belt assembly may be omitted. In such embodiments, the bale wrap feeding assembly may include additional feed rollers to drive the bale wrap toward the bale. Furthermore, while the bale wrap feeding assembly includes a single fixed feed roller in the illustrated embodiment, in other embodiments, the bale wrap feeding assembly may include multiple fixed feed rollers (e.g., 2, 3, 4, 5, 6, or more).

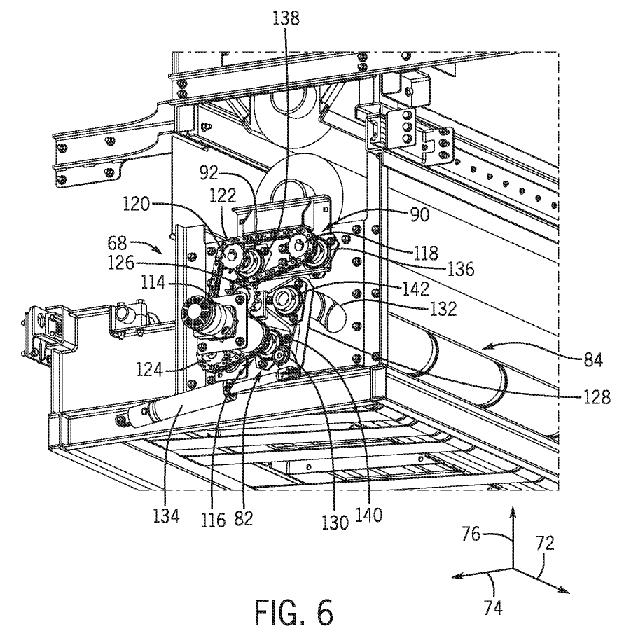

FIG. 6 is a perspective view of a portion of the bale wrap feeding assembly 68 of FIG. 3. In the illustrated embodiment, the bale wrap feeding assembly 68 includes a hydraulic motor 114 configured to drive the first support roller 90, the second support roller 92, the fixed feed roller 82, and the belts of the belt assembly to rotate. As previously discussed, with the movable feed roller 84 in the illustrated engaged position, the movable feed roller gear engages the fixed feed roller gear, such that rotation of the fixed feed roller 82 drives rotation of the movable feed roller 84. Accordingly, the first support roller 90, the second support roller 92, the movable feed roller 84, the fixed feed roller 82, and the belts are driven to rotate by a single hydraulic motor 114. As a result, the cost and complexity of the bale wrap feeding assembly 68 may be reduced (e.g., as compared to a bale wrap feeding assembly having multiple motors).

In the illustrated embodiment, a fixed feed roller drive gear 116 is non-rotatably coupled to the fixed feed roller 82, a first support roller drive gear 118 is non-rotatably coupled to the first support roller 90, and a second support roller drive gear 120 is non-rotatably coupled to the second support roller 92. In addition, the fixed feed roller drive gear 116, the first support roller drive gear 118, and the second support roller drive gear 120 engage a chain 122 (e.g., roller drive chain). In the illustrated embodiment, a shaft of the hydraulic motor 114 is non-rotatably coupled to the fixed feed roller drive gear 116. Accordingly, rotation of the shaft of the hydraulic motor 114 drives the fixed feed roller gear 116 to rotate, which drives the first and second support roller drive gears to rotate via the chain 112. As such, the first support roller 90, the second support roller 92, and the fixed feed roller 82 are driven to rotate by the hydraulic motor 114. While the shaft of the hydraulic motor 114 is non-rotatably coupled to the fixed feed roller drive gear 116 in the illustrated embodiment, in other embodiments, the shaft of the hydraulic motor may be non-rotatably coupled to any other suitable gear, or the shaft of the hydraulic motor may be non-rotatably coupled to an additional gear that is engaged with the chain.

Furthermore, in the illustrated embodiment, the bale wrap feeding assembly 68 includes a belt driving gear 124 engaged with the chain 122. The belt driving gear 124 is rotatably and non-movably coupled to the frame 70. As discussed in detail below, the belt driving gear 124 is configured to drive the belts of the belt assembly to rotate. In addition, in the illustrated embodiment, the bale wrap feeding assembly 68 includes a tension adjustment gear 126 engaged with the chain 122. The tension adjustment gear 126 is rotatably and movably coupled to the frame 70. The position of the tension adjustment gear 126 may be adjusted to control the tension of the chain 122. While the bale wrap feeding assembly 68 includes gears and a chain 122 in the illustrated embodiment, in other embodiments, the bale wrap feeding assembly may include pullies (e.g., a first support roller drive pully, a second support roller drive pully, a tension adjustment pully, a fixed feed roller drive pully, and a belt driving pully) and a belt engaged with the pullies. Furthermore, in certain embodiments, at least one component may be driven to rotate by at least one other motor. For example, the first support roller and the second support roller may be driven to rotate by one motor, and the fixed feed roller and the belts may be driven to rotate by another motor. By way of further example, the belts may be driven to rotate by a first motor, the fixed feed roller may be driven to rotate by a second motor, and the first support roller and the second support roller may be driven to rotate by a third motor.

As previously discussed, the movable feed roller 84 is movable between the illustrated engaged position and the disengaged position relative to the fixed feed roller 82. In the illustrated embodiment, the movable feed roller 84 is rotatably and non-movably coupled to a first arm 128, and the first arm 128 is pivotally coupled to the frame 70 at a first pivot joint 130. In addition, as discussed in detail below, the movable feed roller 84 is also rotatably and non-movably coupled to a second arm, and the second arm is pivotally coupled to the frame at a second pivot joint. The first and second arms are positioned on opposite lateral sides of the frame. The arms and pivot joints enable the movable feed roller 84 to move relative to the frame 70. Accordingly, the movable feed roller 84 is rotatably and movably coupled to the frame 70. Furthermore, in the illustrated embodiment, the frame 70 has a first slot 132 and a second slot positioned on opposite lateral sides of the frame 70. The slots facilitate movement of the movable feed roller 84 between the illustrated engaged position and the disengaged position.

In the illustrated embodiment, the bale wrap feeding assembly 68 includes a first actuator 134 (e.g., first movable feed roller actuator) configured to drive the movable feed roller 84 to move between the illustrated engaged position and the disengaged position. The first actuator 134 is pivotally coupled to the frame 70 and to the first arm 128. In addition, as discussed in detail below, the bale wrap feeding assembly 68 includes a second actuator configured to drive the movable feed roller to move between the engaged and disengaged position, and the first and second actuators are positioned on opposite lateral sides of the frame. The first and second actuators are configured to drive the first and second arms to pivot about the respective pivot joints, thereby driving the movable feed roller to move between the engaged and disengaged positions. In the illustrated embodiment, the first actuator 134 includes a hydraulic cylinder. However, in other embodiments, the first actuator may include other suitable actuation device(s) (e.g., alone or in combination with the hydraulic cylinder), such as a pneumatic cylinder, an electric linear actuator, etc.

In the illustrated embodiment, the first support roller 90 is rotatably and non-movably coupled to the frame 70 by a respective first bearing assembly 136 and a respective second bearing assembly, and the second support roller 92 is rotatably and non-movably coupled to the frame 70 by a respective first bearing assembly 138 and a respective second bearing assembly. In addition, the fixed feed roller 82 is rotatably and non-movably coupled to the frame 70 by a respective first bearing assembly 140 and a respective second bearing assembly. Furthermore, the movable feed roller 84 is rotatably and non-movably coupled to the first arm 128 by a respective first bearing assembly 142, and the movable feed roller 84 is rotatably and non-movably coupled to the second arm by a respective second bearing assembly. The first bearing assemblies and the second bearing assemblies are positioned on opposite lateral sides of the frame, and each bearing assembly is configured to facilitate rotation of the respective roller. While each roller is rotatably supported by respective bearing assemblies in the illustrated embodiment, in other embodiments, at least one roller may be rotatably supported by other suitable connections, such as bushing assemblies, etc.

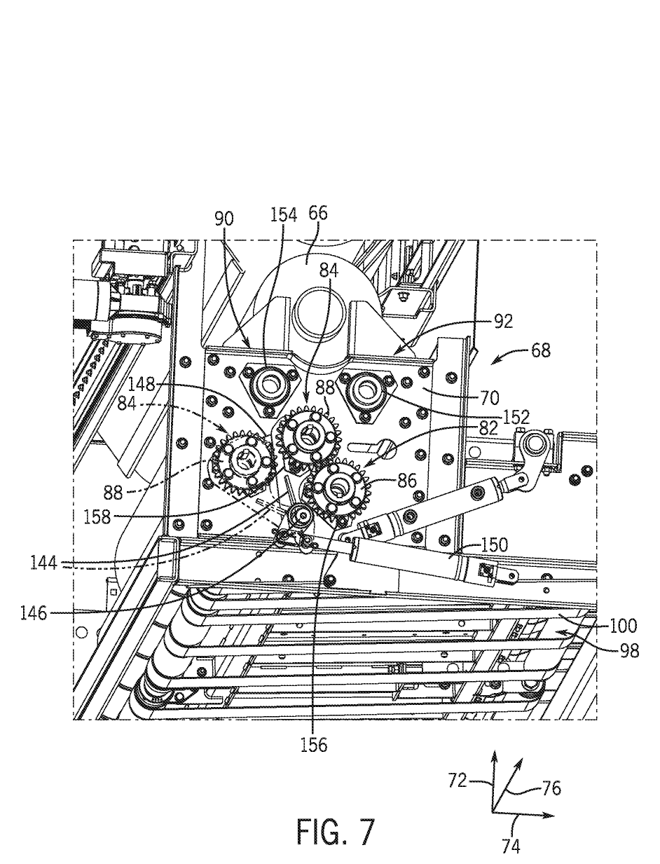

FIG. 7 is a perspective view of a portion of the bale wrap feeding assembly 68 of FIG. 3. As previously discussed, the movable feed roller 84 is rotatably and non-movably coupled to the second arm 144, and the second arm 144 is pivotally coupled to the frame 70 at the second pivot joint 146. The first and second arms and the first and second pivot joints enable the movable feed roller 84 to move between the engaged position, as shown in solid lines, and the disengaged position, as shown in dashed lines. Furthermore, in the illustrated embodiment, the frame 70 has the second slot 148, and the first and second slots facilitate movement of the movable feed roller 84 between the engaged position and the disengaged position. As previously discussed, the movable feed roller 84 is configured to be positioned proximate to the fixed feed roller 82 while in the engaged position to facilitate feeding the bale wrap between the movable feed roller 84 and the fixed feed roller 82, and the movable feed roller 84 is configured to be positioned remote from the fixed feed roller 82 while in the disengaged position to facilitate loading the bale wrap between the movable feed roller 84 and the fixed feed roller 82.

In the illustrated embodiment, the bale wrap feeding assembly 68 includes the second actuator 150 (e.g., second movable feed roller actuator) configured to drive the movable feed roller 84 to move between the engaged position and the disengaged position. The second actuator 148 is pivotally coupled to the frame 70 and to the second arm 144. As previously discussed, the first and second actuators are configured to drive the first and second arms to pivot about the respective pivot joints, thereby driving the movable feed roller to move between the engaged and disengaged positions. In the illustrated embodiment, the second actuator 150 includes a hydraulic cylinder. However, in other embodiments, the second actuator may include other suitable actuation device(s) (e.g., alone or in combination with the hydraulic cylinder), such as a pneumatic cylinder, an electric linear actuator, etc. While the bale wrap feeding assembly 68 includes two actuators for driving the movable feed roller 84 to move in the illustrated embodiment, in other embodiments, the bale wrap feeding assembly may include more or fewer actuators configured to drive the movable feed roller to move, such as 1, 3, 4, or more. Furthermore, in certain embodiments, one or more motors (e.g., alone or in combination with the actuator(s)) may drive the arms to rotate. In addition, in certain embodiments, the arms may be omitted, and one or more actuators may directly drive the movable feed roller to move between the engaged and disengaged positions.

In addition, as previously discussed, the bale wrap feeding assembly 68 includes the fixed feed roller gear 86 non-rotatably coupled to the fixed feed roller 82, and the bale wrap feeding assembly 68 includes the movable feed roller gear 88 non-rotatably coupled to the movable feed roller 84. The movable feed roller gear 88 is configured to engage the fixed feed roller gear 86 while the movable feed roller 84 is in the engaged position to enable rotation of the fixed feed roller 82 to drive rotation of the movable feed roller 84. In addition, the movable feed roller gear 88 is configured to disengage the fixed feed roller gear 86 while the movable feed roller 84 is in the disengaged position, such that the movable feed roller 84 is not driven to rotate while in the disengaged position. While gears are non-rotatably coupled to the movable and fixed feed rollers in the illustrated embodiment, in other embodiments, a fixed feed roller wheel may be non-rotatably coupled to the fixed feed roller, and a movable feed roller wheel may be non-rotatably coupled to the movable feed roller. In such embodiments, the movable feed roller wheel is configured to engage the fixed feed roller wheel while the movable feed roller is in the engaged position to enable rotation of the fixed feed roller to drive rotation of the movable feed roller.

As previously discussed, the first support roller 90 is rotatably and non-movably coupled to the frame 70 by the respective first bearing assembly and the respective second bearing assembly 152, and the second support roller 92 is rotatably and non-movably coupled to the frame 70 by the respective first bearing assembly and the respective second bearing assembly 154. In addition, the fixed feed roller 82 is rotatably and non-movably coupled to the frame 70 by the respective first bearing assembly and the respective second bearing assembly 156. Furthermore, the movable feed roller 84 is rotatably and non-movably coupled to the first arm by the respective first bearing assembly, and the movable feed roller 84 is rotatably and non-movably coupled to the second arm 144 by the respective second bearing assembly 158. As previously discussed, the first bearing assemblies and the second bearing assemblies are positioned on opposite lateral sides of the frame, and each bearing assembly is configured to facilitate rotation of the respective roller.

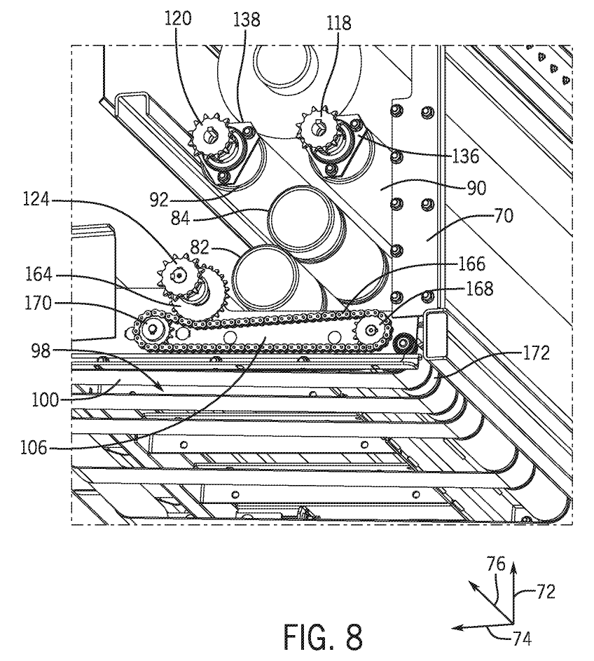

FIG. 8 is a perspective view of a portion of the bale wrap feeding assembly 68 of FIG. 3. As previously discussed, the belt driving gear 124 is configured to drive the belts 100 of the belt assembly 98 to rotate. In the illustrated embodiment, the belt driving gear 124 is non-rotatably coupled to a secondary belt driving gear 164, and the secondary belt driving gear 164 is rotatably and non-movably coupled to the frame 70. Furthermore, the secondary belt driving gear 164 is engaged with a belt driving chain 166. In the illustrated embodiment, the belt assembly 98 includes a drive gear 168 rotatably and non-movably coupled to the chassis 106, and the belt assembly 98 includes an idler gear 170 rotatably and non-movably coupled to the chassis 106. As illustrated, the belt driving chain 166 is engaged with the drive gear 168 and the idler gear 170, and the drive gear is non-rotatably coupled to a drive roller 172 of the belt assembly 98. Accordingly, as the roller drive chain drives the belt driving gear 124 to rotate, the belt driving gear 124 drives the second belt driving gear 164 to rotate, thereby driving the belt driving chain 166 to rotate. In addition, rotation of the belt driving chain 166 drives the idler gear 170 and the drive gear 168 to rotate, thereby driving the drive roller 172 to rotate. The drive roller 172 is engaged with the belts 100 of the belt assembly 98. Accordingly, rotation of the drive roller 172 drives the belts 100 to rotate. As such, the belt driving gear 124 drives the belts 100 of the belt assembly 98 to rotate. The rotational speed of the belts 100 relative to the rotational speed of the roller drive chain may be selected by selecting a gear ratio between the belt drive gear 124 and the secondary belt drive gear 164.

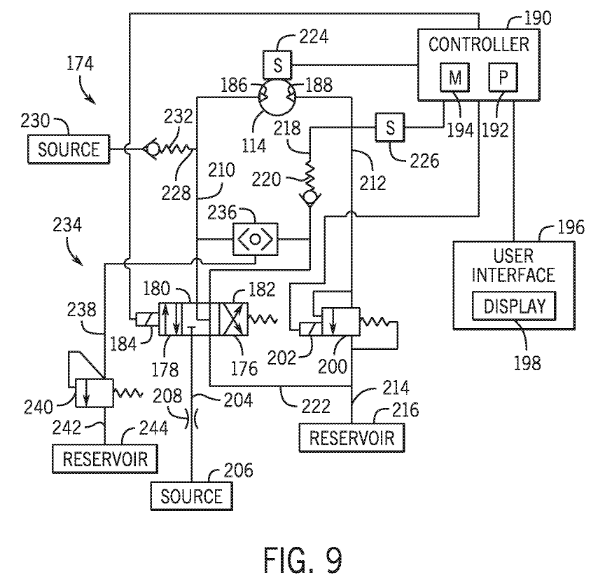

FIG. 9 is a schematic diagram of an embodiment of a hydraulic control system 174 that may be employed within the bale wrap feeding assembly of FIG. 3. As previously discussed, the hydraulic motor 114 of the bale wrap feeding assembly is configured to drive the bale wrap toward the bale while being driven to rotate in a forward direction. For example, in certain embodiments, the hydraulic motor 114 is configured to drive the first support roller, the second support roller, the fixed feed roller, the movable feed roller, and the belts of the belt assembly to rotate in respective forward directions to drive the bale wrap toward the bale. While the bale wrap feeding assembly includes one hydraulic motor 114 in the illustrated embodiment, in other embodiments, the bale wrap feeding assembly may include multiple hydraulic motors (e.g., 2, 3, 4, or more) configured to drive the bale wrap toward the bale while being driven in the forward direction.

The hydraulic control system 174 includes a control valve 176 configured to control hydraulic fluid flow to and from the hydraulic motor 114. In the illustrated embodiment, the control valve 176 is a three-position valve having a first position 178, a second position 180, and a third position 182. In addition, the control valve 176 has a solenoid 184 configured to control the position of the control valve 176 (e.g., to move the control valve 176 between the first, second, and third positions). The control valve 176 is configured to enable hydraulic fluid to flow from a source to a first side 186 of the hydraulic motor 114 to drive the hydraulic motor 114 to rotate in the forward direction while the control valve 176 is in the first position. In addition, the control valve 176 is configured to enable hydraulic fluid to flow from the source to a second side 188 of the hydraulic motor 114 to drive the hydraulic motor 114 to rotate in a backward direction, opposite the forward direction, while the control valve 176 is in the third position 182.

In the illustrated embodiment, the hydraulic control system 174 includes a controller 190 communicatively coupled to the solenoid 184 of the control valve 176. In certain embodiments, the controller 190 is an electronic controller having electrical circuitry configured to control the control valve 176. In the illustrated embodiment, the controller 190 includes a processor 192, such as a microprocessor, and a memory device 194. The controller 190 may also include one or more storage devices and/or other suitable components. The processor 192 may be used to execute software, such as software for controlling the control valve 176, and so forth. Moreover, the processor 192 may include multiple microprocessors, one or more “general-purpose” microprocessors, one or more special-purpose microprocessors, and/or one or more application specific integrated circuits (ASICs), or some combination thereof. For example, the processor 192 may include one or more reduced instruction set (RISC) processors.

The memory device 194 may include a volatile memory, such as random access memory (RAM), and/or a nonvolatile memory, such as read-only memory (ROM). The memory device 194 may store a variety of information and may be used for various purposes. For example, the memory device 194 may store processor-executable instructions (e.g., firmware or software) for the processor 192 to execute, such as instructions for controlling the control valve 176, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the control valve 176, etc.), and any other suitable data.

In the illustrated embodiment, the hydraulic control system 174 includes a user interface 196 communicatively coupled to the controller 190. The user interface 196 is configured to receive input from an operator and to provide information to the operator. The user interface 196 may include any suitable input device(s) for receiving input, such as a keyboard, a mouse, button(s), switch(es), knob(s), other suitable input device(s), or a combination thereof. In addition, the user interface 196 may include any suitable output device(s) for presenting information to the operator, such as speaker(s), indicator light(s), other suitable output device(s), or a combination thereof. In the illustrated embodiment, the user interface 196 includes a display 198 configured to present visual information to the operator. In certain embodiments, the display 198 may include a touchscreen interface configured to receive input from the operator.

In the illustrated embodiment, the hydraulic control system 174 includes a proportional relief valve 200 fluidly coupled to the second side of the hydraulic motor 114. As discussed in detail below, the proportional relief valve 200 is configured to control a pressure of the hydraulic fluid flowing from the second side 188 of the hydraulic motor 114. In the illustrated embodiment, the proportional relief valve 200 includes a solenoid 202 configured to control the proportional relief valve 200, and the solenoid 202 of the proportional relief valve 200 is communicatively coupled to the controller 190. Accordingly, the controller 190 is configured to control the proportional relief valve 200 to control the pressure of the hydraulic fluid flowing from the second side 188 of the hydraulic motor 114.

Furthermore, in the illustrated embodiment, the hydraulic control system 174 includes an inlet conduit 204 fluidly coupled to the control valve 176 and configured to provide hydraulic fluid (e.g., pressurized hydraulic fluid) from a source 206 to the control valve 176. The source 206 may include any suitable type(s) of fluid source(s), such as hydraulic pump(s) and hydraulic fluid reservoir(s). In the illustrated embodiment, the hydraulic control system 174 includes a flow restriction 208 disposed along the inlet conduit 204. The flow restriction 208 is configured to limit a flow rate of the hydraulic fluid from the source 206 to the control valve 176. In certain embodiments, the flow restriction has a fixed flow rate limit (e.g., 1 liter per minute, 2 liters per minute, 4 liters per minute, 6 liters per minute, 8 liters per minute, etc.). However, in other embodiments, the flow restriction is controllable (e.g., manually, via the controller, etc.) to enable an operator to vary the flow rate limit. Furthermore, in certain embodiments, the flow restriction may be omitted.

In addition, the hydraulic control system 174 includes a first hydraulic motor conduit 210 fluidly coupled to the control valve 176 and to the first side 186 of the hydraulic motor 114 (e.g., extending between the control valve 176 and the first side 186 of the hydraulic motor 114). The hydraulic control system 174 also includes a second hydraulic motor conduit 212 fluidly coupled to the second side 188 of the hydraulic motor 114 and to the proportional relief valve 200 (e.g., extending between the second side 188 of the hydraulic motor 114 and the proportional relief valve 200). In addition, the hydraulic control system 174 includes a first drain conduit 214 fluidly coupled to the proportional relief valve 200 and to a reservoir 216 (e.g., extending between the proportional relief valve 200 and the reservoir 216). Furthermore, the hydraulic control system 174 includes a control valve conduit 218 fluidly coupled to the second hydraulic motor conduit 212 and to the control valve 176 (e.g., extending between the second hydraulic motor conduit 212 and the control valve 176). In the illustrated embodiment, a check valve 220 is disposed along the control valve conduit 218. The check valve 220 is configured to block fluid flow from the second hydraulic motor conduit 212 (e.g., from the second side 188 of the hydraulic motor 114) to the control valve 176 and to enable fluid flow from the control valve 176 to the second hydraulic motor conduit 212 (e.g., to the second side 188 of the hydraulic motor 114).

To wrap the bale with the bale wrap of the active bale wrap assembly, the hydraulic motor 114 is driven to rotate in the forward direction, thereby driving the first support roller, the second support roller, the movable feed roller, the fixed feed roller, and the belts to rotate in respective forward directions, which drive the bale wrap toward the bale (e.g., feeds the bale wrap to the starter roller). To drive the hydraulic motor 114 to rotate in the forward direction, the operator may provide an input to the user interface 196 indicative of instructions to drive the bale wrap toward the bale. The user interface 196, in turn, may output a signal to the controller 190 indicative of the instructions, and the controller 190 may control the control valve 176 to move to the first position 178. While the control valve 176 is in the first position 178, hydraulic fluid flows from the source 206, through the inlet conduit 204, the flow restrictor 208, the control valve 176, and the first hydraulic motor conduit 210 to the first side 186 of the hydraulic motor 114. As a result, the hydraulic motor 114 is driven to rotate in the forward direction. In addition, hydraulic fluid drains from the second side 188 of the hydraulic motor 114 through the second hydraulic motor conduit 212, the proportional relief valve 200, and the first drain conduit 214 to the reservoir 216. Hydraulic fluid flow through the control valve conduit 218 is blocked by the check valve 220. Furthermore, to facilitate flow of the hydraulic fluid from the second hydraulic motor conduit 212 (e.g., from the second side 188 of the hydraulic motor 114) through the proportional relief valve 200 while the control valve 176 is in the first position 178, the controller 190 controls the proportional relief valve 200 to open or to apply a low pressure reduction (e.g., a minimum pressure reduction). For example, in response to receiving the signal from the user interface 190 indicative of the instructions to drive the bale wrap toward the bale, the controller 190 may control the proportional relief valve 200 to open or to apply the low pressure reduction, thereby enabling the hydraulic fluid to flow from the second side 188 of the hydraulic motor 114 to the reservoir 216.

Furthermore, to drive the bale wrap away from the bale (e.g., to return the bale wrap to the active bale wrap assembly, to facilitate adjustment of the bale wrap, etc.), the hydraulic motor 114 may be driven to rotate in the backward direction, opposite the forward direction, which drives the first support roller, the second support roller, the movable feed roller, the fixed feed roller, and the belts to rotate in respective backward directions. To drive the hydraulic motor 114 to rotate in the backward direction, the operator may provide an input to the user interface 196 indicative of instructions to drive the bale wrap away from the bale. The user interface 196, in turn, may output a signal to the controller 190 indicative of the instructions, and the controller 190 may control the control valve 176 to move to the third position 182. While the control valve 176 is in the third position 182, hydraulic fluid flows from the source 206, through the inlet conduit 204, the flow restrictor 208, the control valve 176, the control valve conduit 218, the check valve 220, and the second hydraulic motor conduit 212 to the second side 188 of the hydraulic motor 114. As a result, the hydraulic motor 114 is driven to rotate in the backward direction. In addition, hydraulic fluid drains from the first side 186 of the hydraulic motor 114 through the first hydraulic motor conduit 210, the control valve 176, a second drain conduit 222, and the first drain conduit 214 to the reservoir 216. As illustrated, the second drain conduit 222 is fluidly coupled to the control valve 176 and to the first drain conduit 214 (e.g., extending between the control valve 176 and the first drain conduit 214). Furthermore, to block flow of the hydraulic fluid from the second hydraulic motor conduit 212 through the proportional relief valve 200 while the control valve 176 is in the third position 182, the controller 190 controls the proportional relief valve 200 to close. For example, in response to receiving the signal from the user interface 190 indicative of the instructions to drive the bale wrap away from the bale, the controller 190 may control the proportional relief valve 200 to close, thereby blocking hydraulic fluid flow from the second hydraulic motor conduit 212 to the first drain conduit 214.

While the bale wrap feeding assembly is configured to selectively drive the bale wrap away from the bale in the illustrated embodiment, in other embodiments, the bale wrap feeding assembly may not be configured to drive the bale wrap away from the bale. In such embodiments, the hydraulic motor may be configured to only rotate in the forward direction. Additionally or alternatively, the third position of the control valve may be omitted (e.g., the control valve may only have the first position and the second position).

In the illustrated embodiment, the hydraulic control system 174 includes a speed sensor 224 communicatively coupled to the controller 190. The speed sensor 224 is configured to output a sensor signal indicative of a speed (e.g., rotation speed) of the hydraulic motor 114. The speed sensor 224 may include any suitable type(s) of speed sensing device(s), such as infrared sensor(s), optical sensor(s), magnetic sensor(s), inductive sensor(s), other suitable type(s) of sensing device(s), or a combination thereof. The speed sensor 224 may monitor the speed of the hydraulic motor 114 directly or indirectly via any element driven by the hydraulic motor 114 (e.g., a feed roller, a belt, etc.). During operation of the bale wrap feeding assembly, the controller 190 is configured to receive the sensor signal from the speed sensor 224 indicative of the speed of the hydraulic motor 114.

In response to determining the speed of the hydraulic motor 114 is greater than a threshold speed, the controller 190 is configured to control the control valve 176 to move to the second position 180 and to control the proportional relief valve 200 to control a pressure of the hydraulic fluid flowing from the second side 188 of the hydraulic motor 114. While the control valve 176 is in the second position 180, flow of the hydraulic fluid from the source 206 to the hydraulic motor 114 is blocked. In addition, the hydraulic fluid may flow from the reservoir 216, through the first drain conduit 214, the second drain conduit 222, the control valve 176, and the first hydraulic motor conduit 210 to the first side 186 of the hydraulic motor 114. Furthermore, hydraulic fluid may drain from the second side 188 of the hydraulic motor through the second hydraulic motor conduit 212, the proportional relief valve 200, and the first drain conduit 214 to the reservoir 216. However, the pressure of the hydraulic fluid flowing from the second side 188 of the hydraulic motor 114 through the second hydraulic motor conduit 212 is controlled by the proportional relief valve 200.

As previously discussed, as the bale wrap is fed toward the bale, the bale wrap is captured between the bale and the belt(s) that form the bale. Accordingly, rotation of the bale draws the bale wrap around the bale, thereby wrapping the bale. For example, while the control valve 176 is in the first position, the hydraulic motor 114 may be driven in the forward direction at a first speed (e.g., 30 RPM, 40 RPM, 50 RPM, 60 RPM, 70 RPM, etc.), thereby driving the bale wrap toward the bale. In response to the bale wrap being captured between the bale and the belt(s) that form the bale, the speed of the bale wrap through the bale wrap feeding assembly may increase, thereby causing the hydraulic motor to rotate in the forward direction at a second speed (e.g., 80 RPM, 90 RPM, 100 RPM, 110 RPM, 120 RPM, etc.), higher than the first speed. The threshold speed may be selected to be above the first speed and at or below the second speed. Accordingly, the controller may determine that the bale wrap is captured between the bale and the belt(s) that form the bale in response to determining the speed of the hydraulic motor is greater than the threshold speed.

As indicated above, in response to determining the speed of the hydraulic motor 114 is greater than the threshold speed, the controller 190 is configured to control the control valve 176 to move to the second position 180 and to control the proportional relief valve 200 to control the pressure of the hydraulic fluid flowing from the second side 188 of the hydraulic motor 114. Controlling the pressure of the hydraulic fluid flowing from the second side 188 of the hydraulic motor 114 controls a rotational resistance of the hydraulic motor in the forward direction (e.g., a resistance to rotation of the hydraulic motor in the forward direction), thereby controlling a rotational resistance of the rollers and the belts of the bale wrap feeding assembly in the respective forward directions. For example, while the control valve 176 is in the second position 180 and the hydraulic motor 114 is being driven to rotate in the forward direction by movement of the bale wrap, hydraulic fluid may flow from the reservoir 216, through the first drain conduit 214, the second drain conduit 222, the control valve 176, and the first hydraulic motor conduit 210 to the first side 186 of the hydraulic motor 114. In addition, while the control valve 176 is in the second position 180 and the hydraulic motor 114 is being driven to rotate in the first direction by movement of the bale wrap, hydraulic fluid may flow from the second side 188 of the hydraulic motor 114 through the second hydraulic motor conduit 212, the proportional relief valve 200, and the first drain conduit 214 to the reservoir 216. As a result, rotation of the hydraulic motor 114 in the forward direction is enabled. However, the controller 190 controls the proportional relief valve 200 to control the pressure of the hydraulic fluid flowing from the second side 188 of the hydraulic motor 114, thereby controlling the rotational resistance of the hydraulic motor 114, which controls the rotational resistance of the rollers and the belts of the bale wrap feeding assembly.

The rotational resistance of the rollers and the belts may be controlled by controlling the pressure of the hydraulic fluid flowing from the second side of the hydraulic motor to establish tension within the bale wrap. The rotational resistance of the rollers and the belts of the bale wrap feeding assembly may be controlled by controlling the pressure of the hydraulic fluid flowing from the second side of the hydraulic motor, such that the rollers and the belts cause the bale wrap to move slower at the bale wrap feeding assembly than at the bale, thereby establishing tension within the bale wrap, which stretches the bale wrap (e.g., by 5 percent, by 10 percent, by 15 percent, etc.). Stretching the bale wrap facilitates adhesion of the bale wrap to itself as the bale wrap wraps around the bale, thereby coupling the bale wrap to the bale. Furthermore, the tension within the bale wrap may substantially maintain the round shape of the bale, thereby facilitating storage and transport of the wrapped bale. In addition, maintaining tension within the bale wrap may substantially reduce or eliminate the possibility of loose bale wrap material collecting within the agricultural machine system, thereby substantially reducing or eliminating the possibility of bale wrap clogging.

In certain embodiments, in response to determining the speed of the hydraulic motor 114 is greater than the threshold speed, the controller 190 may control the proportional relief valve 200 to control the pressure of the hydraulic fluid flowing from the second side 188 of the hydraulic motor 114 based on the speed of the hydraulic motor. For example, as the speed of the hydraulic motor 114 increases, the controller 190 may control the proportional relief valve 200 to increase the pressure of the hydraulic fluid flowing from the second side 188 of the hydraulic motor 114, thereby increasing the rotational resistance of the hydraulic motor 114 and, thus, the rotational resistance of the rollers and belts of the bale wrap feeding assembly. Furthermore, as the speed of the hydraulic motor 114 decreases, while being above the threshold speed, the controller 190 may control the proportional relief valve 200 to decrease the pressure of the hydraulic fluid flowing from the second side 188 of the hydraulic motor 114, thereby decreasing the rotational resistance of the hydraulic motor 114 and, thus, the rotational resistance of the rollers and belts of the bale wrap feeding assembly. In certain embodiments, in response to determining the speed of the hydraulic motor 114 is greater than the threshold speed, the controller 190 may control the proportional relief valve 200 such that the speed of the hydraulic motor 114 is within a threshold range of a target speed. For example, if the target speed is 100 RPM and the threshold range is 5 RPM, the controller 190 may control the proportional relief valve 200 to establish a hydraulic motor speed of 95 RPM to 105 RPM. The target speed may be selected to establish a desired tension within the bale wrap. For example, the target speed may be 80 RPM, 90 RPM, 100 RPM, 110 RPM, or 120 RPM. Furthermore, any suitable threshold range may be selected (e.g., 1 RPM, 2 RPM, 5 RPM, 10 RPM, etc.).

The controller 190 may utilize a relationship between the speed of the hydraulic motor 114 and the pressure of the hydraulic fluid flowing from the second side 188 of the hydraulic motor 114 (e.g., stored within the controller) to control the proportional relief valve 200 based on the speed of the hydraulic motor 114. In certain embodiments, the relationship may be represented as a curve (e.g., linear, quadratic, cubic, etc.), or an empirical formula (e.g., cubic spline fit, etc.). Accordingly, the controller 190 may control the proportional relief valve 200 to change the pressure of the hydraulic fluid flowing from the second side 188 of the hydraulic motor 114 based on a difference between the speed of the hydraulic motor 114 (e.g., as determined based on feedback from the speed sensor 224) and the target speed and the relationship between the speed of the hydraulic motor 114 and the pressure of the hydraulic fluid flowing from the second side 188 of the hydraulic motor 114.

In the illustrated embodiment, the hydraulic control system 174 includes a pressure sensor 226 fluidly coupled to the second hydraulic motor conduit 212 and communicatively coupled to the controller 190. The pressure sensor 226 is configured to output a sensor signal (e.g., second sensor signal) indicative of the pressure of the hydraulic fluid flowing from the second side 188 of the hydraulic motor 114. The pressure sensor 226 may include any suitable type(s) of pressure sensing device(s), such as a piezoelectric sensor, a capacitive sensor, etc. The controller 190 is configured to receive the sensor signal indicative of the pressure of the hydraulic fluid flowing from the second side 188 of the hydraulic motor 114. Furthermore, in certain embodiments, in response to determining the speed of the hydraulic motor is greater than the threshold speed, the controller 190 is configured to control the proportional relief valve 200 to control pressure of the hydraulic fluid flowing from the second side 188 of the hydraulic motor 114 based on the pressure of the hydraulic fluid flowing from the second side 188 of the hydraulic motor 114 (e.g., as determined based on feedback from the pressure sensor 226). In certain embodiments, in response to determining the speed of the hydraulic motor 114 is greater than the threshold speed, the controller 190 may control the proportional relief valve 200 such that the pressure of the hydraulic fluid flowing from the second side 188 of the hydraulic motor 114 is within a threshold range of a target pressure. The target pressure may be selected to establish a desired tension within the bale wrap. Furthermore, any suitable threshold range may be selected. While the hydraulic control system 174 includes the pressure sensor 226 in the illustrated embodiment, in other embodiments, the pressure sensor may be omitted. In such embodiments, the controller may control the proportional relief valve based on the speed of the hydraulic motor, as discussed above.

In the illustrated embodiment, the hydraulic control system 174 includes a supplemental hydraulic fluid conduit 228 configured to selectively provide additional hydraulic fluid to the first side 186 of the hydraulic motor 114 while the control valve 176 is in the second position 180 (e.g., while the hydraulic motor 114 is being driven to rotate in the forward direction by movement of the bale wrap). The supplemental hydraulic fluid conduit 228 is fluidly coupled to the first hydraulic motor conduit 210 and to a source 230 (e.g., extending between the first hydraulic motor conduit 210 and the source 230). The source 230 may include any suitable type(s) of fluid source(s), such as hydraulic pump(s) and hydraulic fluid reservoir(s). While the inlet conduit 204 is fluidly coupled to one source 206 and the supplemental hydraulic fluid conduit 228 is fluidly coupled to another source 230 in the illustrated embodiment, in certain embodiments, the inlet conduit and the supplemental hydraulic fluid conduit may be coupled to the same source (e.g., the sources 206 and 230 may be the same source). In the illustrated embodiment, a check valve 232 is disposed along the supplemental hydraulic fluid conduit 228. The check valve 232 is configured to block fluid flow from the first hydraulic motor conduit 210 (e.g., from the first side 186 of the hydraulic motor 114) to the source 230. In addition, the check valve 232 is configured to enable fluid flow from the source 230 to the first hydraulic motor conduit 210 (e.g., to the first side 186 of the hydraulic motor 114) while the pressure of the hydraulic fluid at the source 230 is greater than the pressure of the hydraulic fluid flowing through the first hydraulic motor conduit 210 by more than a margin (e.g., which may be established by a spring within the check valve 232).

As previously discussed, while the control valve 176 is in the second position 180 and the hydraulic motor 114 is being driven to rotate in the forward direction by movement of the bale wrap, hydraulic fluid may flow from the reservoir 216, through the first drain conduit 214, the second drain conduit 222, the control valve 176, and the first hydraulic motor conduit 210 to the first side 186 of the hydraulic motor 114. In addition, while the control valve 176 is in the second position 180 and the hydraulic motor 114 is being driven to rotate in the forward direction by movement of the bale wrap, hydraulic fluid may flow from the second side 188 of the hydraulic motor 114 through the second hydraulic motor conduit 212, the proportional relief valve 200, and the first drain conduit 214 to the reservoir 216. As a result, rotation of the hydraulic motor 114 in the forward direction is enabled. As the speed of the hydraulic motor 114 increases, the pressure of the hydraulic fluid flowing through the first hydraulic motor conduit 210 may decrease. Once the pressure of the hydraulic fluid at the source 230 is greater than the pressure of the hydraulic fluid flowing through the first hydraulic motor conduit 210 by more than the margin of the check valve 232, the check valve 232 may open, thereby providing additional fluid from the source 230 to the first side 186 of the hydraulic motor 114. As a result, the possibility of cavitation within the hydraulic motor 114 may be substantially reduced or eliminated. The margin of the check valve 232 may be selected such that the check valve 232 opens before the hydraulic fluid within the hydraulic motor 114 cavitates. While the hydraulic control system 174 includes the supplemental hydraulic fluid conduit 228 and the check valve 232 in the illustrated embodiment, in other embodiments, the supplemental hydraulic fluid conduit and the check valve may be omitted.

Furthermore, in the illustrated embodiment, the hydraulic control system 174 includes a hydraulic fluid drain assembly 234 configured to drain the hydraulic fluid in response to the pressure of the hydraulic fluid at the first side 186 of the hydraulic motor 114 or the second side 188 of the hydraulic motor 114 exceeding a threshold pressure. The hydraulic fluid drain assembly 234 includes a shuttle valve 236 fluidly coupled to the first hydraulic motor conduit 210 and to the control valve conduit 218. The hydraulic fluid drain assembly 234 also includes a third drain conduit 238, a pressure relieving valve 240, and a fourth drain conduit 242. The third drain conduit 238 is fluidly coupled to the shuttle valve 236 and to the pressure relieving valve 240 (e.g., extending between the shuttle valve 236 and the pressure relieving valve 240). In addition, the fourth drain conduit 242 is fluidly coupled to the pressure relieving valve 240 and to a reservoir 244 (e.g., extending between the pressure relieving valve 240 and the reservoir 244). While the first drain conduit 214 is fluidly coupled to one reservoir 216 and the fourth drain conduit 242 is fluidly coupled to another reservoir 244 in the illustrated embodiment, in certain embodiments, the first drain conduit and the fourth drain conduit may be coupled to the same reservoir (e.g., the reservoirs 216 and 244 may be the same reservoir). The pressure relieving valve 240 is configured to automatically open in response to the pressure of the hydraulic fluid within the third drain conduit 238 exceeding the threshold pressure. The threshold pressure may be selected based on the operating pressure of the hydraulic motor 114. For example, the threshold pressure may be 15 bar, 20 bar, 25 bar, etc. The shuttle valve 236 is configured to direct the hydraulic fluid from the first hydraulic motor conduit 210 to the third drain conduit 238 if the pressure of the hydraulic fluid within the first hydraulic motor conduit 210 is greater than the pressure of the hydraulic fluid within the control valve conduit 218, and the shuttle valve 236 is configured to direct the hydraulic fluid from the control valve conduit 218 to the third drain conduit 238 if the pressure of the hydraulic fluid within the control valve conduit 218 is greater than the pressure of the hydraulic fluid within the first hydraulic motor conduit 210. Accordingly, the hydraulic fluid drain assembly 234 is configured to drain the hydraulic fluid from the higher pressure conduit (e.g., the control valve conduit 218 or the first hydraulic motor conduit 210) to the reservoir 244 while the pressure of the hydraulic fluid within the higher pressure conduit is greater than the threshold pressure, thereby limiting the pressure of the hydraulic fluid within the hydraulic motor 114. While the hydraulic control system 174 includes the hydraulic fluid drain assembly 234 in the illustrated embodiment, in other embodiments, the hydraulic fluid drain assembly may be omitted.

While the hydraulic motor 114 is configured to drive the first support roller, the second support roller, the fixed feed roller, the movable feed roller, and the belts of the belt assembly, as disclosed above with reference to FIGS. 4-8, to rotate in certain embodiments, in other embodiments, the hydraulic motor may be configured to drive any other suitable roller(s) and/or belt(s) to rotate to drive the bale wrap toward the bale and, in certain embodiments, away from the bale. Furthermore, while the rollers and belts, as disclosed above with reference to FIGS. 4-8, are coupled to a movable frame, in certain embodiments, the hydraulic motor may be configured to drive roller(s) and/or belt(s), which are coupled to a non-movable frame, to rotate. The hydraulic control system 174 disclosed above may be utilized with any suitable hydraulic motor(s) configured to drive the bale wrap toward the bale and, in certain embodiments, away from the bale (e.g., via any suitable combination of roller(s) and/or belt(s)).

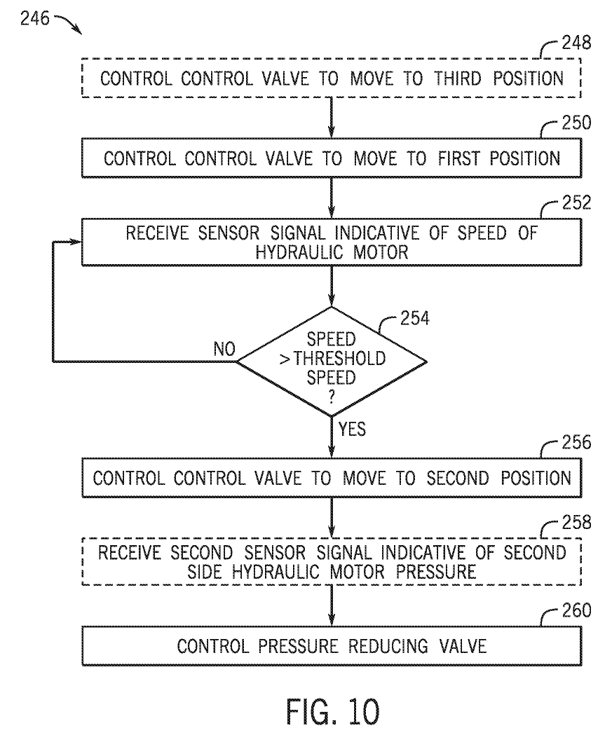

FIG. 10 is a flow diagram of an embodiment of a method 246 for controlling a hydraulic motor of a bale wrap feeding assembly. The method 246 may be performed by the controller disclosed above with reference to FIG. 9, by one or more other suitable controllers, or a combination thereof. Furthermore, the steps of the method 246 may be performed in the order disclosed below or in any other suitable order. In addition, in certain embodiments, one or more steps of the method 246 may be omitted, and/or the method may include one or more additional steps.

In the illustrated embodiment, the method includes controlling the control valve to move to the third position, as represented by block 248. As previously discussed, the control valve is configured to enable the hydraulic fluid to flow from the source to the second side of the hydraulic motor while the control valve is in the third position, thereby driving the hydraulic motor to rotate in the backward direction, opposite the forward direction. While the method 246 includes the step of controlling the control valve to move to the third position (e.g., block 248) in the illustrated embodiment, in other embodiments (e.g., in embodiments in which the control valve does not include the third position), the step of controlling the control valve to move to the third position (e.g., block 248) may be omitted. Furthermore, in the illustrated embodiment, the method 246 includes controlling the control valve to move to the first position, as represented by block 250. As previously discussed, the control valve is configured to enable the hydraulic fluid to flow from the source to the first side of the hydraulic motor while the control valve is in the first position, thereby driving the hydraulic motor to rotate in the forward direction.

The method 246 also includes receiving a sensor signal indicative of a speed of the hydraulic motor, as represented by block 252. As previously discussed, the sensor signal may be received from a speed sensor configured to monitor the speed of the hydraulic motor. Furthermore, the method 246 includes comparing the speed of the hydraulic motor to a threshold speed, as represented by block 254. In response to determining the speed of the hydraulic motor is greater than the threshold speed, the method proceeds to block 256. Otherwise, the method returns to block 252. As represented by block 256, the method 246 includes controlling the control valve to move to the second position. As previously discussed, the control valve is configured to enable the hydraulic fluid to flow from the reservoir to the first side of the hydraulic motor and to enable the hydraulic fluid to flow from the second side of the hydraulic motor to the proportional relief valve, thereby enabling the proportional relief valve to control the pressure of the hydraulic fluid flowing from the second side of the hydraulic motor.

In certain embodiments (e.g., in embodiments in which the proportional relief valve is controlled based on the pressure of the hydraulic fluid flowing from the second side of the hydraulic motor), the method 246 includes receiving a second sensor signal indicative of the pressure of the hydraulic fluid flowing from the second side of the hydraulic motor, as represented by block 258. However, in other embodiments (e.g., in embodiments in which the proportional relief valve is controlled based on the speed of the hydraulic motor), the step of receiving the second sensor signal indicative of the pressure of the hydraulic fluid flowing from the second side of the hydraulic motor (e.g., block 258) may be omitted.

Furthermore, the method 246 includes controlling the proportional relief valve to control the pressure of the hydraulic fluid flowing from the second side of the hydraulic motor, as represented by block 260. In certain embodiments, controlling the proportional relief valve includes controlling the proportional relief valve to control the pressure of the hydraulic fluid flowing from the second side of the hydraulic motor based on the speed of the hydraulic motor. For example, controlling the proportional relief valve may include controlling the proportional relief valve such that the speed of the hydraulic motor is within a threshold range of a target speed. Furthermore, in certain embodiments (e.g., in embodiments including the step of receiving the second sensor signal indicative of the pressure of the hydraulic fluid flowing from the second side of the hydraulic motor), controlling the proportional relief valve includes controlling the proportional relief valve to control the pressure of the hydraulic fluid flowing from the second side of the hydraulic motor based on the pressure of the hydraulic fluid flowing from the second side of the hydraulic motor. For example, controlling the proportional relief valve may include controlling the proportional relief valve such that the pressure of the hydraulic fluid flowing from the second side of the hydraulic motor is within a threshold range of a target pressure.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A hydraulic control system for a bale wrap feeding assembly of an agricultural harvester, comprising:
a controller comprising a processor an a memory, wherein the controller is configured to:
control a control valve to move to a first position to enable hydraulic fluid to flow from a source to a first side of a hydraulic motor to drive the hydraulic motor to rotate in a forward direction, wherein the hydraulic motor is configured to drive a bale wrap toward a bale while being driven to rotate in the forward direction;
receive a sensor signal indicative of a speed of the hydraulic motor; and
in response to determining the speed of the hydraulic motor is greater than a threshold speed:
control the control valve to move to a second position to enable the hydraulic fluid to flow from a reservoir to the first side of the hydraulic motor and to enable the hydraulic fluid to flow from a second side of the hydraulic motor to a proportional relief valve; and
control the proportional relief valve to control a pressure of the hydraulic fluid flowing from the second side of the hydraulic motor.

2. The hydraulic control system of claim 1, wherein the controller, in response to determining the speed of the hydraulic motor is greater than the threshold speed, is configured to control the proportional relief valve to control the pressure of the hydraulic fluid flowing from the second side of the hydraulic motor based on the speed of the hydraulic motor.

3. The hydraulic control system of claim 2, wherein the controller, in response to determining the speed of the hydraulic motor is greater than the threshold speed, is configured to control the proportional relief valve such that the speed of the hydraulic motor is within a threshold range of a target speed.

4. The hydraulic control system of claim 1, wherein the controller is configured to:
receive a second sensor signal indicative of the pressure of the hydraulic fluid flowing from the second side of the hydraulic motor; and
in response to determining the speed of the hydraulic motor is greater than the threshold speed, control the proportional relief valve to control the pressure of the hydraulic fluid flowing from the second side of the hydraulic motor based on the pressure of the hydraulic fluid flowing from the second side of the hydraulic motor.

5. The hydraulic control system of claim 4, wherein the controller, in response to determining the speed of the hydraulic motor is greater than the threshold speed, is configured to control the proportional relief valve such that the pressure of the hydraulic fluid flowing from the second side of the hydraulic motor is within a threshold range of a target pressure.

6. The hydraulic control system of claim 1, wherein the controller is configured to control the control valve to move to a third position to enable the hydraulic fluid to flow from the source to the second side of the hydraulic motor to drive the hydraulic motor to rotate in a backward direction, opposite the forward direction.

7. A bale wrap feeding assembly for an agricultural harvester, comprising:
a hydraulic motor configured to drive a bale wrap toward a bale while being driven to rotate in a forward direction; and
a hydraulic control system, comprising:
a speed sensor configured to output a sensor signal indicative of a speed of the hydraulic motor;
a proportional relief valve;
a control valve having a first position and a second position, wherein the control valve is configured to enable hydraulic fluid to flow from a source to a first side of the hydraulic motor to drive the hydraulic motor to rotate in the forward direction while the control valve is in the first position, and the control valve is configured to enable the hydraulic fluid to flow from a reservoir to the first side of the hydraulic motor and to enable the hydraulic fluid to flow from a second side of the hydraulic motor to the proportional relief valve while the control valve is in the second position; and
a controller communicatively coupled to the speed sensor, the proportional relief valve, and the control valve, wherein the controller comprises a processor and a memory, and the controller is configured to:
receive the sensor signal indicative of the speed of the hydraulic motor; and
in response to determining the speed of the hydraulic motor is greater than a threshold speed:
control the control valve to move to the second position; and
control the proportional relief valve to control a pressure of the hydraulic fluid flowing from the second side of the hydraulic motor.

8. The bale wrap feeding assembly of claim 7, wherein the controller, in response to determining the speed of the hydraulic motor is greater than the threshold speed, is configured to control the proportional relief valve to control the pressure of the hydraulic fluid flowing from the second side of the hydraulic motor based on the speed of the hydraulic motor.

9. The bale wrap feeding assembly of claim 8, wherein the controller, in response to determining the speed of the hydraulic motor is greater than the threshold speed, is configured to control the proportional relief valve such that the speed of the hydraulic motor is within a threshold range of a target speed.

10. The bale wrap feeding assembly of claim 7, wherein the hydraulic control system comprises a pressure sensor configured to output a second sensor signal indicative of the pressure of the hydraulic fluid flowing from the second side of the hydraulic motor, wherein the pressure sensor is communicatively coupled to the controller; and
wherein the controller is configured to:
receive the second sensor signal indicative of the pressure of the hydraulic fluid flowing from the second side of the hydraulic motor; and
in response to determining the speed of the hydraulic motor is greater than the threshold speed, control the proportional relief valve to control the pressure of the hydraulic fluid flowing from the second side of the hydraulic motor based on the pressure of the hydraulic fluid flowing from the second side of the hydraulic motor.

11. The bale wrap feeding assembly of claim 10, wherein the controller, in response to determining the speed of the hydraulic motor is greater than the threshold speed, is configured to control the proportional relief valve such that the pressure of the hydraulic fluid flowing from the second side of the hydraulic motor is within a threshold range of a target pressure.

12. The bale wrap feeding assembly of claim 7, wherein the control valve has a third position, the control valve is configured to enable the hydraulic fluid to flow from the source to the second side of the hydraulic motor to drive the hydraulic motor to rotate in a backward direction, opposite the forward direction, while the control valve is in the third position.

13. The bale wrap feeding assembly of claim 7, wherein the hydraulic control system comprises a hydraulic fluid drain assembly configured to drain the hydraulic fluid in response to the pressure of the hydraulic fluid at the first side of the hydraulic motor or the second side of the hydraulic motor exceeding a threshold pressure.

14. The bale wrap feeding assembly of claim 7, wherein the hydraulic control system comprises a supplemental hydraulic fluid conduit configured to selectively provide additional hydraulic fluid to the first side of the hydraulic motor while the control valve is in the second position.

15. A method for controlling a hydraulic motor of a bale wrap feeding assembly, comprising:
controlling, via a controller having a processor and a memory, a control valve to move to a first position to enable hydraulic fluid to flow from a source to a first side of the hydraulic motor to drive the hydraulic motor to rotate in a forward direction, wherein the hydraulic motor is configured to drive a bale wrap toward a bale while being driven to rotate in the forward direction;
receiving, via the controller, a sensor signal indicative of a speed of the hydraulic motor; and
in response to determining the speed of the hydraulic motor is greater than a threshold speed:
controlling, via the controller, the control valve to move to a second position to enable the hydraulic fluid to flow from a reservoir to the first side of the hydraulic motor and to enable the hydraulic fluid to flow from a second side of the hydraulic motor to a proportional relief valve; and
controlling, via the controller, the proportional relief valve to control a pressure of the hydraulic fluid flowing from the second side of the hydraulic motor.

16. The method of claim 15, wherein controlling the proportional relief valve comprises controlling the proportional relief valve to control the pressure of the hydraulic fluid flowing from the second side of the hydraulic motor based on the speed of the hydraulic motor.

17. The method of claim 16, wherein controlling the proportional relief valve comprises controlling the proportional relief valve such that the speed of the hydraulic motor is within a threshold range of a target speed.

18. The method of claim 15, comprising receiving, via the controller, a second sensor signal indicative of the pressure of the hydraulic fluid flowing from the second side of the hydraulic motor, wherein controlling the proportional relief valve comprises controlling the proportional relief valve to control the pressure of the hydraulic fluid flowing from the second side of the hydraulic motor based on the pressure of the hydraulic fluid flowing from the second side of the hydraulic motor.

19. The method of claim 18, wherein controlling the proportional relief valve comprises controlling the proportional relief valve such that the pressure of the hydraulic fluid flowing from the second side of the hydraulic motor is within a threshold range of a target pressure.

20. The method of claim 15, comprising controlling, via the controller, the control valve to move to a third position to enable the hydraulic fluid to flow from the source to the second side of the hydraulic motor to drive the hydraulic motor to rotate in a backward direction, opposite the forward direction.
